(19) United States
(12) Patent Application Publication
(10) Pub. No.: US 2007/0054155 A1
(43) Pub. Date: Mar. 8, 2007

(54) Alkaline fuel cell comprising an anode consisting of aluminum and zinc and method for producing one such anode

(75) Inventors: Emmanuel Damery, Crolles (FR); Didier Marsacq, Grenoble (FR); Christel Roux, Saint-Quentin-Sur-Isere (FR); Max Perrin, Le Fontanil Comillon (FR)

Correspondence Address: OLIFF & BERRIDGE, PLC, P.O. BOX 19928, ALEXANDRIA, VA, 22320, US

(73) Assignee: Commissariat A L'ENERGIE ATOMIQUE, Paris (FR)

(21) Appl. No.: 10/574,929

(22) PCT Filed: Oct. 13, 2004
(86) PCT No.: PCT/FR04/02608

§ 371 Date: Apr. 7, 2006

(30) Foreign Application Priority Data
Oct. 15, 2003 (FR) 0312058

(51) Int. Cl. H01M 2/00

(52) U.S. Cl. 429/1; 428/100

(57) ABSTRACT

An alkaline fuel cell comprises at least one electrolyte having an anode disposed thereon. The anode is formed by a stack of a first thin layer and a second thin layer disposed between the electrolyte and the first thin layer. The first thin layer consists of aluminium or an aluminium alloy whereas the second thin layer preferably consists of zinc or a zinc alloy. The anode of the alkaline fuel cell is preferably produced by depositing the second thin layer designed to come into contact with the electrolyte, by physical vapor deposition, on a substrate formed by the aluminium or aluminium alloy first thin layer.

### BACKGROUND OF THE INVENTION

The invention relates to an alkaline fuel cell comprising at least one electrolyte on which is disposed an anode comprising at least first and second thin layers respectively including aluminium and zinc.

The invention also relates to a method for producing an anode of one such alkaline fuel cell.

### STATE OF THE ART

Alkaline fuel cells are generally primary, i.e. not rechargeable, battery cells, and they are generally used in portable electronic devices. They are the seat:
of an oxidation reaction of a metal anode according to the following reaction:
   M→Mⁿ⁺+ne⁻
and of a reduction reaction of the oxygen of the air, in an alkaline environment, according to the following reaction:
   ½O₂+H₂O+2e⁻→2 OH⁻
   Thus, the operating balance of this type of battery cells is the following:
   2M+n/2O₂+nH₂O⇄2(OH)ₙ
   where M represents the metal of the anode and n represents the degree of oxidation of the metal M.

According to the metal used for the anode, corrosion can however limit the operation of the fuel cell. Aluminium anodes are therefore little used as they are subjected to very high corrosion. The highly electronegative potential of aluminium in an aqueous environment does in fact induce a breakdown of water into hydrogen and spontaneous dissolution of aluminium. Furthermore, the natural passivation layer of aluminium is not stable in an alkaline environment.

The document WO-A-9607765 describes an alkaline battery cell comprising a zinc powder containing 0.0005% to 1% aluminium, 0.0001% to 2% of at least one element chosen from bismuth, indium and gallium, at least one element chosen from magnesium, strontium, barium and the metallic rare earths. The elements are designed to limit corrosion of the anode. The aluminium contained in the powder however remains in contact with the electrolyte and can therefore be subjected to corrosion.

To limit corrosion of the anode, it is also known to arrange a thin layer between the anode and the electrolyte designed to protect the anode against corrosion. The protective layer is generally passive in operation of the battery cell and can form a shield against the electrochemical reaction. Thus, to enable satisfactory operation of the battery, the protective layer can be made porous by adding elements in the protective layer that are active when the battery is operating.

Thus, in the document JP 4,104,464, the negative electrode consists of zinc or of a zinc alloy and is covered by a gallium alloy containing from 0.1% to 15% in weight of aluminium. When the battery is operating, the aluminium contained in a low proportion in the gallium alloy dissolves and generates a certain porosity in the gallium coating so as to enable operation of the zinc electrode. Such a battery however has a lower efficiency than a battery comprising an aluminium anode and the gallium protective layer is relatively costly. Indeed, with an aluminium anode, the theoretical mass energy is 8050Wh/kg whereas it is 2360Wh/kg with a zinc anode.

The U.S. Pat. No. 5,316,632 describes a method for improving the efficiency of an electrochemical cell by selectively and cyclically controlling the dissolution and inhibition of an aluminium electrode immersed in an electrolytic aqueous solution. Thus, when the electrochemical cell is inactive, a passivation layer is deposited on the aluminium electrode, by precipitation of lead, nickel or zinc. Then, for operation of the cell, the passivation layer is eliminated electrochemically so as to enable deposition, on the surface of the electrode, of an activation layer obtained by precipitation of tin, indium, gallium or copper. At the end of the operating period of the cell, the activation layer is eliminated to enable deposition of a new passivation layer. Although such a method enables the aluminium electrode to be protected against corrosion when the electrochemical cell is not operating, this method proves difficult to implement as it requires a large number of steps involving depositions by precipitation and electrochemical eliminations of passivation and activation layers.

### OBJECT OF THE INVENTION

It is an object of the invention to provide an alkaline fuel cell remedying the shortcomings of the prior art, and more particularly in which the anode is temporarily protected against corrosion while ensuring that the cell has a high efficiency.

According to the invention, this object is achieved by the fact that the first thin layer consists of aluminium or of an aluminium alloy, the second thin layer being disposed between the first thin layer and the electrolyte.

According to a development of the invention, the second thin layer consists of zinc or of a zinc alloy.

According to one feature of the invention, the anode consists of an alternation of first and second thin layers.

It is another object of the invention to provide a method for producing an anode of such a fuel cell that is easy to implement and inexpensive.

According to the invention, this object is achieved by the fact that the method consists in depositing at least one second thin layer designed to come into contact with the electrolyte and comprising zinc, by physical vapor deposition, on a substrate formed by a first thin layer made of aluminium or an aluminium alloy.

### BRIEF DESCRIPTION OF THE DRAWINGS

Other advantages and features will become more clearly apparent from the following description of particular embodiments of the invention given as non-restrictive examples only and represented in the accompanying drawings, in which:

FIG. 1 represents a first embodiment of a fuel cell according to the invention, in cross-section.

FIG. 2 represents an alternative embodiment of a fuel cell according to the invention, in cross-section.

### DESCRIPTION OF PARTICULAR EMBODIMENTS

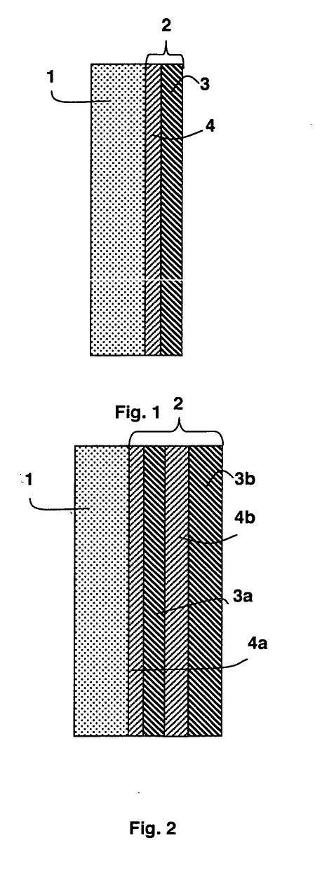

According to a first embodiment illustrated in FIG. 1, an alkaline fuel cell comprises at least one electrolyte 1 whereon an anode 2 is disposed. The anode 2 consists of a stack of a first thin layer 3 and a second thin layer 4, said second thin layer being disposed between the electrolyte 1 and the first thin layer 3. The first thin layer 3 consists of aluminium or of an aluminium alloy whereas the second thin layer 4 consists of zinc or of a zinc alloy.

By aluminium alloy, what is meant is an alloy comprising at least 75% weight of aluminium and by zinc alloy, what is meant is an alloy comprising at least 75% weight of zinc.

The first and second thin layers preferably have a thickness comprised between 10 nm and 100 μm and the second thin layer can preferably have a smaller thickness than that of the first thin layer.

Zinc dissolution kinetics being slower than those of aluminium, arranging a second thin layer of zinc or of an zinc alloy between the electrolyte and the first thin layer of aluminium or of an aluminium alloy enables the first layer to be temporarily protected against corrosion, while preserving a high operating efficiency. As the second thin layer plays the role of sacrificial layer, it is in fact also oxidized and therefore participates, by dissolution thereof, in operation of the alkaline fuel cell while temporarily protecting the first thin layer against corrosion. In this way, when the alkaline fuel cell is operating, the zinc of the second thin layer progressively dissolves according to the following reaction Zn+½O₂+H₂O⇄Zn(OH)₂ so as to generate a porosity and it generates an electric current. Dissolution of the zinc may continue until the latter has totally disappeared. Then the aluminium of the first thin layer is consumed according to the following reaction 2Al+3/2O₂+3H₂O⇄2Al(OH)₃.

The anode 2 of the alkaline fuel cell is preferably achieved by depositing the second thin layer 4 designed to come into contact with the electrolyte 1, by physical vapor deposition, on a substrate formed by the first thin layer 3 made of aluminium or an aluminium alloy.

Such a fuel cell presents the advantage of being able to adapt the configuration of the anode to a predetermined consumption profile of the fuel cell. Thus, by varying the thickness of the first and second thin layers, the storage time of the fuel cell can be adjusted. For example, considering that the zinc layer consumed during non-use of the cell is subjected to a corrosion current of 0.8 mA/cm², if this layer has a thickness of 100 μm, the storage time of the cell is 72 hours whereas for a zinc layer with a thickness of 10 nm, the storage time is 26 seconds.

In an alternative embodiment, the anode 2, as represented in FIG. 2, can be formed by an alternation of first and second thin layers 3 and 4, respectively made of aluminium or an aluminium alloy and of zinc or an zinc alloy, a second thin layer 4 necessarily being in contact with the electrolyte 1. In this case, the anode is preferably achieved by depositing an alternation of first and second layers 3 and 4, by physical vapor deposition, on a second thin layer 4, previously deposited on an aluminium or aluminium alloy substrate. Moreover, the thicknesses of the first thin layers 3 and/or the thicknesses of the second thin layers 4 can be different.

Thus, in FIG. 2, the anode consists of a successive stack of four thin layers formed by an alternation of two first thin layers and two second thin layers. Thus, a zinc or zinc alloy second thin layer 4a is disposed between the electrolyte 1 and an aluminium or aluminium alloy first thin layer 3a. An additional second thin layer 4b, of the same type as the second thin layer 4a and preferably thicker, is disposed between the first thin layer 3a and an additional first thin layer 3b of the same type as the first thin layer 3a and preferably thicker. In addition, the thickness of each second thin layer 4a or 4b is preferably smaller than the thickness of the corresponding first thin layer 3a or 3b.

Such an alternative embodiment can enable a more complex consumption profile to be obtained. Thus, for a cell requiring a high power every hour so as for example to transmit data, the anode comprising an alternation of first and second layers, the second layer comprising zinc is then chose so as to supply a power consumption of one hour and the first layer comprising aluminium supplies the power necessary for data transmission. Thus, a cell operating for 24 hours preferably comprises an alternation of 24 first layers and 24 second layers. Likewise, a weekly operation can be envisaged with hourly or daily periods of use using layers of different thicknesses.

1. Alkaline fuel cell comprising at least one electrolyte on which is disposed an anode comprising at least:
one first thin layer consisting of aluminum or an aluminum alloy
and one second thin layer comprising zinc and disposed between the first thin layer and the electrolytes.

2. Fuel cell according to claim 1, wherein the second thin layer consists of zinc.

3. Fuel cell according to claim 1, wherein the second thin layer consists of a zinc alloy.

4. Fuel cell according to claim 1, wherein the thickness of each thin layer is comprised between 10 nm and 100 μm.

5. Fuel cell according to claim 1, wherein the anode consists of an alternation of first and second thin layers.

6. Method for producing an anode of an alkaline fuel cell according to claim 1 and consisting in depositing at least one second thin layer designed to come into contact with the electrolyte and comprising zinc, by physical vapor deposition, on a substrate formed by a first thin layer made of aluminium or an aluminium alloy.

7. Method for producing according to claim 6, wherein an alternation of first and second thin layers is deposited on the second thin layer by physical vapor deposition.
